(19) United States
(12) Patent Application Publication
(10) Pub. No.: US 2026/0105558 A1
(43) Pub. Date: Apr. 16, 2026

(54) METHOD AND APPARATUS FOR EVALUATING WILDFIRE EVACUATION VULNERABILITY

(71) Applicant: CORNERS CO., LTD., Seoul (KR)

(72) Inventors: Dongju KA, Seoul (KR); Koohong CHUNG, Seoul (KR); Sung Won SHIN, Seoul (KR); Jang Won CHOI, Seoul (KR); Dong Oh KIM, Seoul (KR)

(73) Assignee: CORNERS CO., LTD., Seoul (KR)

(21) Appl. No.: 19/194,321

(22) Filed: Apr. 30, 2025

(30) Foreign Application Priority Data
Oct. 16, 2024 (KR) 10-2024-0140991

(51) Int. Cl. G06Q 50/26

(52) U.S. Cl. CPC G06Q 50/265

(57) ABSTRACT

Disclosed is a method and apparatus for evaluating wildfire evacuation vulnerability. A wildfire evacuation vulnerability evaluation method may include identifying wildfire vulnerable areas and critical roads for wildfire evacuation within the wildfire vulnerable areas through a wildfire evacuation vulnerability measure based on origin-destination pairs and failure probability for each road due to wildfires.

### CROSS-REFERENCE TO RELATED APPLICATION

This application claims the priority benefit of Korean Patent Application No. 10-2024-0140991, filed on Oct. 16, 2024, in the Korean Intellectual Property Office, the disclosure of which is incorporated herein by reference.

### BACKGROUND

### 1. Field of the Invention

The following example embodiments relate to technology for identifying wildfire-vulnerable areas that are prone to failure for wildfire evacuation, and locating critical roads within each vulnerable area during wildfire evacuation.

### 2. Description of the Related Art

The 2018 Camp Fire in Butte County, California, was one of the most destructive wildfires ever recorded in California. It occurred due to a blaze caused by a faulty power line, which burned more than 153,000 acres, killed 85 people, and destroyed more than 18,800 structures. The California Department of Forestry and Fire Protection (CALFIRE) reports that, among the deadliest and most destructive wildfires in California history, power line problems or electrical causes account for the largest proportion (refer to FIG. 1).

According to several studies, climate change and population growth in areas in which wildfires may occur are contributing to the increase in frequency of wildfires and human casualties. Also, the fact that many of the deadliest and most destructive wildfires have occurred over the past 20 years supports that environmental change may continuously worsen the wildfire risk. As the frequency and scale of damage associated with these wildfires increases, public authorities and experts from various fields are discussing various responses to address this risk. However, implementing countermeasures at all necessary positions is not only expensive but also requires years of planning and construction.

Previous studies using traffic simulations to evaluate wildfire evacuation strategies assume a variety of evacuation scenarios that encompass various factors, such as road closures due to hazard from debris and fire, residents' compliance with staged evaluation plans, and initial location of the fire.

Simulation-based studies may be used to estimate evaluation indicators that include isolated vehicles (IVs), evaluation time estimates (ETEs), latency, edge speed, queue length, and total evaluation travel distance, and may be useful to validate evacuation strategies. However, collecting necessary data requires a significant amount of time and may be computationally burdened. Therefore, when evaluating the risk related to every municipality in a state such as California, resources may be lacking. Also, the results of simulation-based studies may be applied only to a specific scenario considered in the analysis.

### SUMMARY

Example embodiments may provide a graph-theoretic method that evaluates network vulnerability using publicly available traffic network data.

Example embodiments may additionally utilize explainable graph-theoretic indicators that consider realistic evacuation origin-destination pairs (hereinafter, referred to as ‘O-D pairs’) and failure probability for each road based on exposure to wildfires.

Example embodiments may provide a comprehensive framework that may systematically identify wildfire-vulnerable areas that are prone to failure for wildfire evacuation due to unreliable network performance from among the entire study areas and may locate critical roads within each vulnerable area during wildfire evacuation.

According to at least one example embodiment, there is provided a wildfire evacuation vulnerability evaluation method of a computer device including at least one processor, the wildfire evacuation vulnerability evaluation method including identifying, by the at least one processor, wildfire vulnerable areas and critical roads for wildfire evacuation within the wildfire vulnerable areas through a wildfire evacuation vulnerability measure based on origin-destination pairs and failure probability for each road due to wildfires.

According to an aspect, the identifying may include calculating wildfire evacuation vulnerability based on the number of vehicles that evacuate from an origin node and escape success probability of people that evacuate from the origin node.

According to another aspect, the identifying may include performing the wildfire evacuation vulnerability measure through a Dijkstra algorithm designed to identify a path with the highest escape success probability from among paths between a set of origins and a set of destinations.

According to still another aspect, the identifying may include comparing evacuation vulnerability between traffic demand sources through a method of using traffic network data to quantify network vulnerability as the average of minimum failure probability of demand for an origin node.

According to still another aspect, the identifying may include identifying links of the critical roads based on a first link criticality measure that considers traffic usage of a link during evacuation and a second link criticality measure that quantifies the overall impact due to link failure.

According to still another aspect, the first link criticality measure may be defined as a value acquired by multiplying the number of evacuation vehicles expected to lose options due to link failure by the failure probability of the corresponding link.

According to still another aspect, the failure probability may be calculated by considering a length of the link and a relative fire threat tier of a traffic analysis zone (TAZ) to which the link belongs.

According to still another aspect, the second link criticality measure may be applied with a normalized measure defined as a gap in vulnerability measure between an original graph and a reduced graph without the link.

According to at least one example embodiment, there is provided a non-transitory computer-readable recording medium storing instructions that, when executed by a processor, cause the processor to perform the wildfire evacuation vulnerability evaluation method on a computer device, wherein the wildfire evacuation vulnerability evaluation method includes identifying wildfire vulnerable areas and critical roads for wildfire evacuation within the wildfire vulnerable areas through a wildfire evacuation vulnerability measure based on origin-destination pairs and failure probability for each road due to wildfires.

According to at least one example embodiment, there is provided a computer device including at least one processor configured to execute computer-readable instructions on the computer device, wherein the at least one processor is configured to process a process of identifying wildfire vulnerable areas and critical roads for wildfire evacuation within the wildfire vulnerable areas through a wildfire evacuation vulnerability measure based on origin-destination pairs and failure probability for each road due to wildfires.

According to some example embodiments, it is possible to provide a comprehensive framework that may systematically identify wildfire-vulnerable areas that are prone to failure for wildfire evacuation due to unreliable network performance from among the entire study areas and may locate critical roads within each vulnerable area during wildfire evacuation, which may lead to facilitating effective distribution of limited resources for preventing planning efforts against the wildfire risk.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates California wildfire report for 2023;

FIG. 2 is a block diagram illustrating an example of an internal configuration of a computer device according to an example embodiment;

FIG. 3 illustrates pseudo-code for a Dijkstra algorithm modified for wildfire evacuation vulnerability measure;

FIG. 4 illustrates a map of wildfire hazard areas defined by the California Public Utilities Commission (CPUC);

FIGS. 5 and 6 summarize the demographic and graph-theoretic characteristics, CPUC ratings, and the number of traffic analysis zones (TAZs) of studied cases;

FIG. 7 illustrates an example of relative fire threat calculated for each municipality's traffic analysis zone (TAZ); and

FIG. 8 illustrates an example of source and destination nodes.

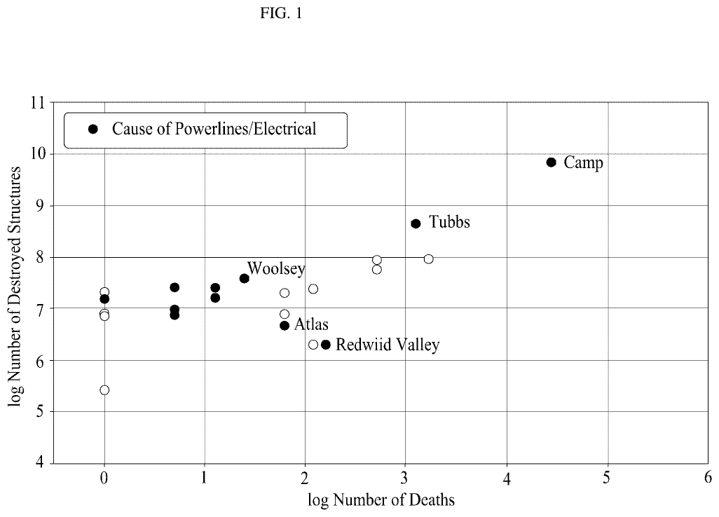

### DETAILED DESCRIPTION

Hereinafter, example embodiments will be described with reference to the accompanying drawings.

The example embodiments relate to technology for identifying wildfire-vulnerable areas that are prone to failure for wildfire evacuation and locating critical roads within each vulnerable area during wildfire evacuation.

The example embodiments including the disclosures set forth herein may provide a comprehensive framework that may systematically identify wildfire-vulnerable areas that are prone to failure for wildfire evacuation due to unreliable network performance from among the entire study areas and may locate critical roads within each vulnerable area during wildfire evacuation, which may lead to facilitating effective distribution of limited resources for preventing planning efforts against the wildfire risk.

A wildfire evacuation vulnerability evaluation apparatus according to example embodiments may be implemented by at least one computer device, and a wildfire evacuation vulnerability evaluation method according to example embodiments may be performed through at least one computer device included in the wildfire evacuation vulnerability evaluation apparatus. Here, a computer program according to an example embodiment may be installed and run on the computer device, and the computer device may perform the wildfire evacuation vulnerability evaluation method according to example embodiments under control of the running computer program. The aforementioned computer program may be stored in a non-transitory computer-readable recording medium to computer-implement the wildfire evacuation vulnerability evaluation method in conjunction with the computer device.

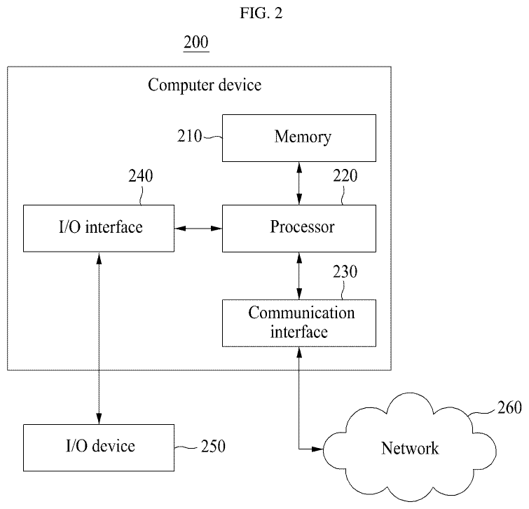

FIG. 2 is a block diagram illustrating an example of a computer device according to an example embodiment. For example, a wildfire evacuation vulnerability evaluation apparatus according to example embodiments may be implemented by a computer device 200 of FIG. 2.

Referring to FIG. 2, the computer device 200 may include a memory 210, a processor 220, a communication interface 230, and an input/output (I/O) interface 240 as components to execute a wildfire evacuation vulnerability evaluation method according to example embodiments.

The memory 210 may include a permanent mass storage device, such as a random access memory (RAM), a read only memory (ROM), and a disk drive, as a non-transitory computer-readable record medium. The permanent mass storage device, such as ROM and a disk drive, may be included in the computer device 200 as a permanent storage device separate from the memory 210. Also, an OS and at least one program code may be stored in the memory 210. Such software components may be loaded to the memory 210 from another non-transitory computer-readable record medium separate from the memory 210. The other non-transitory computer-readable record medium may include a non-transitory computer-readable record medium, for example, a floppy drive, a disk, a tape, a DVD/CD-ROM drive, a memory card, etc. According to other example embodiments, software components may be loaded to the memory 210 through the communication interface 230, instead of the non-transitory computer-readable record medium. For example, the software components may be loaded to the memory 210 of the computer device 200 based on a computer program installed by files received over a network 260.

The processor 220 may be configured to process instructions of the computer program by performing basic arithmetic operations, logic operations, and I/O operations. The computer-readable instructions may be provided by the memory 210 or the communication interface 230 to the processor 220. For example, the processor 220 may be configured to execute received instructions in response to a program code stored in a storage device, such as the memory 210.

The communication interface 230 may provide a function for communication between the computer device 200 and another apparatus over the network 260. For example, the processor 220 of the computer device 200 may forward a request or an instruction created based on a program code stored in the storage device such as the memory 210, data, and a file, to other apparatuses over the network 260 under control of the communication interface 230. Inversely, a signal, an instruction, data, a file, etc., from another apparatus may be received at the computer device 200 through the communication interface 230 of the computer device 200 over the network 260. A signal, an instruction, data, etc., received through the communication interface 230 may be forwarded to the processor 220 or the memory 210, and a file, etc., may be stored in a storage medium, for example, the permanent storage device, further includable in the computer device 200.

The communication scheme is not limited and may include a near field wired/wireless communication scheme between devices as well as a communication scheme using a communication network (e.g., a mobile communication network, wired Internet, wireless Internet, and a broadcasting network) includable in the network 260. For example, the network 260 may include at least one of network topologies that include a personal area network (PAN), a local area network (LAN), a campus area network (CAN), a metropolitan area network (MAN), a wide area network (WAN), a broadband network (BBN), and the Internet. Also, the network 260 may include at least one of network topologies that include a bus network, a star network, a ring network, a mesh network, a star-bus network, a tree or hierarchical network, and the like. However, they are provided as examples only.

The I/O interface 240 may be a device used for interfacing with an I/O device 250. For example, an input device may include a device, such as a microphone, a keyboard, a camera, a mouse, etc., and an output device may include a device, such as a display, a speaker, etc. As another example, the I/O interface 240 may be a device for interfacing with an apparatus in which an input function and an output function are integrated into a single function, such as a touchscreen. The I/O device 250 may be configured as a single apparatus with the computer device 200.

Also, according to other example embodiments, the computer device 200 may include a greater or smaller number of components than the number of components shown in FIG. 2. However, there is no need to clearly illustrate most conventional components. For example, the computer device 200 may be implemented to include at least a portion of the I/O device 250 or may further include other components, such as a transceiver, a camera, various sensors, and a database.

Hereinafter, example embodiments for technology for evaluating wildfire evacuation vulnerability are described in detail.

The frequency and scale of wildfires in California have significantly increased in recent years. Policymakers need to develop responses to mitigate wildfire risk, but need to prioritize interventions since it is expensive to implement some of the responses. Therefore, to assign limited government resources, it is important to identify and rank municipalities (e.g., cities and towns) with vulnerable evacuation paths.

One study (Yun, J., Lee, J., Park, J., Chung, K., & Lee, J. (2022) How to measure the network vulnerability of cities to wildfires: cases in California, USA. Transportation research record, 2676(12), 382-395.) proposed a method to evaluate evacuation vulnerability to wildfires by focusing on how many individuals of the total population would be able to evacuate during a wildfire, in consideration of the capacity of the road network.

The above Yun (2022) uses three existing graph-theoretic proxy measurement values for the road network in each study area, and compares them with Monte Carlo agent-based simulation results for various road closure scenarios. Results of studying three California municipalities, Atascadero, Orinda, and Paradise, showed that Paradise had the network most vulnerable to wildfires in that connectivity based on graph-theoretic proxy measurement values was worst, and intravenous and emergency room simulation measurement values were also worst. In fact, during the Camp Fire, residents of rural areas of Paradise tried to evacuate out of town, but Paradise did not have sufficient road network, resulting in serious casualties. Nevertheless, the measures adopted in the corresponding study only focus on the connectivity between all possible node pairs without considering potential origin-destination (O-D) pairs in wildfire evacuation scenarios. It is important to consider O-D pairs since evacuation destinations, such as highways or main road exits, are different from non-evacuation situations. Also, Yun (2022) does not consider wildfire threat and its impact on each road, which oversimplifies the situation as it may vary depending on the surrounding vegetation and topological importance within the traffic network.

The example embodiments additionally utilize explainable graph-theoretic indicators that consider realistic evacuation O-D pairs and failure probability for each road based on exposure to wildfires to overcome limitations of recent graph-theoretic approaches, and may provide a comprehensive framework that may systematically identify wildfire vulnerable areas prone to failure for wildfire evacuation due to unreliable network performance from among the entire study areas and may locate critical roads within each vulnerable area during wildfire evacuation.

### Evacuation Vulnerability and Critical Link Evaluation

The traffic network in the study area is expressed as a graph {V,E}. Here, V and E represent a set of nodes and a set of directional links, respectively. The number of vehicles that evacuate from origin node o∈O is λ(o) estimated using demographic information and the set of origin nodes is O⊂V. A set of possible destination nodes is given as D⊂V, and each destination node d∈D is at the border of the corresponding area and is connected to a safe zone. An origin of each evacuation vehicle is fixed, but a destination node d may be readily selected from the set D. There may be a plurality of paths that connect the origin node o∈O and the destination node d∈D. For a specific path indexed with k between o and d, a set of links included in this path is Pₖ(o,d), escape success probability is Sₖ(o,d), and this is defined as probability that all links of Pₖ(o,d) will not be closed due to wildfires. The maximum escape success probability between o and d is

$$S ( o , d ) = {max}_{k} {S}_{k} ( o , d )$$

along the corresponding P(o,d), and the escape success probability of a person evacuating from node O is S(o), which is defined as

$${d}^{*} ( o ) = {arg max}_{d ∈ D} S ( o , d ) .$$

### (1) Evacuation Vulnerability Measure

Vulnerability measure (VM), a measure of vulnerability, is proposed, which refers to Equation 1 that quantifies network vulnerability as 1−S(o), which is the average of minimum failure probability of all demands λ(o) for o∈O. The vulnerability measure avoids unnecessary connectivity considerations and unrealistic equilibrium assumption across the entire network and, instead, focuses on actual evacuation O-D pairs and link failure probability in wildfire situations. Normalized measure allows comparison of evacuation vulnerability between traffic sources with different sizes.

$$V M = 1 - \frac{{\sum }_{o ∈ O} λ ( o ) S ( o )}{{\sum }_{o ∈ O} λ ( o )} \qquad [ Equation 1 ]$$

The proposed evaluation for evacuation vulnerability in the traffic network is based on a Dijkstra algorithm that is designed to find a shortest path between two nodes with computational efficiency.

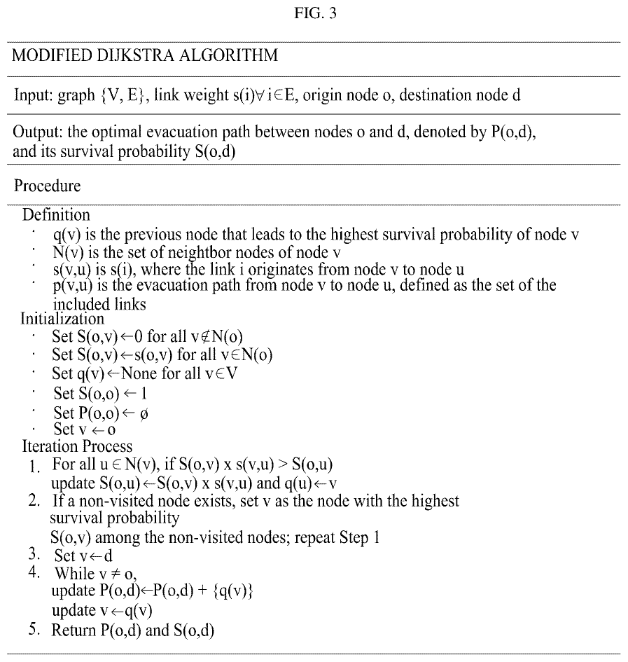

FIG. 3 illustrates pseudo-code for the modified Dijkstra algorithm. As shown in FIG. 3, the Dijkstra algorithm may be modified to identify a path with the highest escape success probability among paths between a specific o set and a d set. To this end, a weight graph may be applied in which s(i) is denoted for all i and f(i) considers the escape success probability of each link identical to 1−f(i) representing the failure probability of link i as a link weight. The example embodiment simplifies link failure (blocking) events to be independent of each other as observed in previous cases in California mainly due to random and sporadic road closures by amber fires. However, when links share surrounding environments, such as vegetation cover, failure rates f(i) may be correlated. For all d∈D, if S(o,d) is determined for each o, S(o) of Equation 1 may be acquired.

### (2) Identify Critical Links for Evacuation

In some areas with limited road capacity, evacuation time may significantly increase when several critical paths on which evacuation paths largely depend are blocked. Links on these critical roads may be identified using a traffic-based link criticality measure

$$( {LC}_{i}^{1} )$$

(see Equation 2) and a network impact-based link criticality measure

$$( {LC}_{i}^{2} )$$

### (see Equation 3).

$${LC}_{i}^{1} = {\sum }_{o ∈ O} λ ( o ) I ( o , i ) f ( i ) , ∀ i ∈ E \qquad [ Equation 2 ]$$

$${LC}_{i}^{2} = \frac{\{ V M ( {G}^{/ \{ i \}} ) - V M ( G ) \} \cdot f ( i )}{{max}_{j ∈ E} [ \{ V M ( {G}^{/ \{ j \}} ) - V M ( G ) \} \cdot f ( j ) ]} , ∀ i ∈ E \qquad [ Equation 3 ]$$

The traffic-based link criticality measure (LCᵢ¹) measures the criticality of each link in consideration of the traffic usage of the link during evacuation. In the case of link i, it is known whether an evacuation path from node o includes this link, [i(o,i)=1 if i∈P(o,d*(o)), or i(o,i)=0 if i∉P(o,d*(o)]. Therefore, the number of evacuation vehicles expected to pass through the link in the evacuation situation is Σ_{o∈O}λ(o)I(o, i). LCᵢ¹ is defined as a value acquired by multiplying the number of evacuation vehicles expected to lose options due to failure of link i, which is considered to have the highest escape success probability, by the failure probability of link i, f(i).

The network impact-based link criticality measure

$$( {LC}_{i}^{2} )$$

quantifies the overall network impact due to the failure of the link i. A normalized measure defined as a gap in VM values between an original graph G and a reduced graph G^{/(i)}=(V, E/{i}) without the link i.

The above criticality measurement method does not quantify the combined damage to the network. However, when a plurality of links fail, it is possible to compare and identify critical links one by one within the study area. Therefore, preventative management may be considered a priority.

### (3) Target Area

A wildfire evacuation vulnerability evaluation method according to the present invention may be applied to, for example, 45 municipalities in California. For comparison, wildfire evacuation vulnerability is further evaluated using Simulation of Urban Mobility (SUMO), a widely used agent-based traffic simulator.

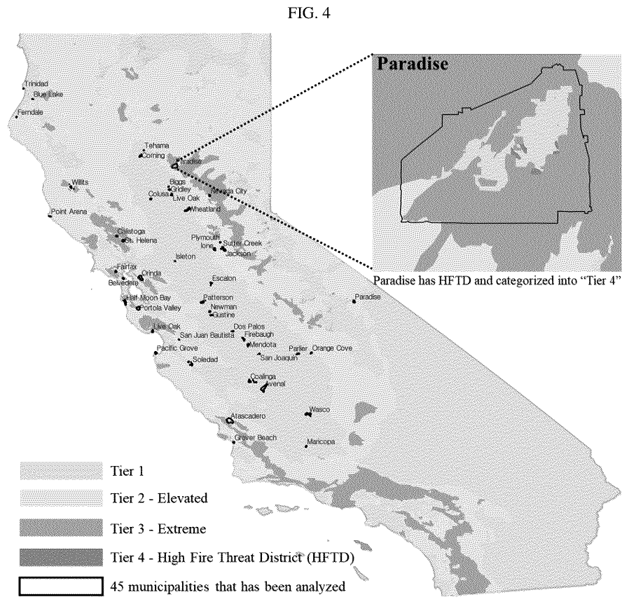

FIG. 4 illustrates a map of wildfire hazard areas defined by the California Public Utilities Commission (CPUC). In FIG. 4, the map shows the 45 municipalities evaluated in the example embodiment. CPUC defines fire threat tiers based on risk levels associated with utility-related wildfires and provides information on Tiers 2, 3, and High Fire Threat District (HFTD) for all areas of California. Tier 2 includes areas at high risk from utility-related wildfires in consideration of both likelihood and potential impact on humans and property. Tier 3 describes areas at extreme risk from utility-related wildfires and considers likelihood and potential impact. In the example embodiment, HFTD is defined as Tier 4 that represents the highest level of wildfire risk. Also, areas not classified as Tier 2, 3, or HFTD are designated as Tier 1. In the example embodiment, FTcpuc that is the original CPCU fire threat rating for each municipality is modified by considering a proportion of areas corresponding to the highest fire threat rating section within the corresponding municipality. The modified fire threat rating is defined as

$${FT}_{modified} = {FT}_{CPUC} + \frac{{A}_{H}}{{A}_{M}} .$$

Here, A_{M} and A_{H} represent the entire municipality and the area in the highest fire threat rating section.

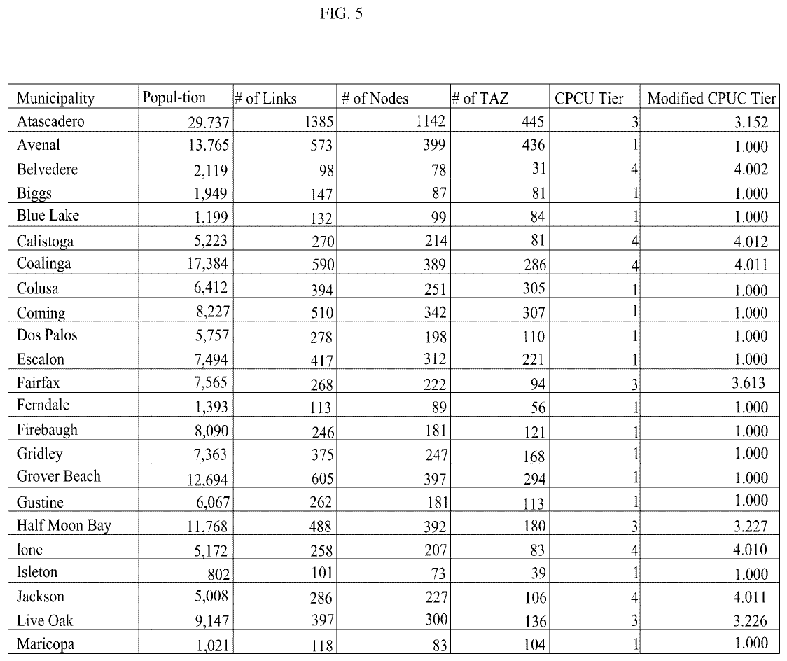

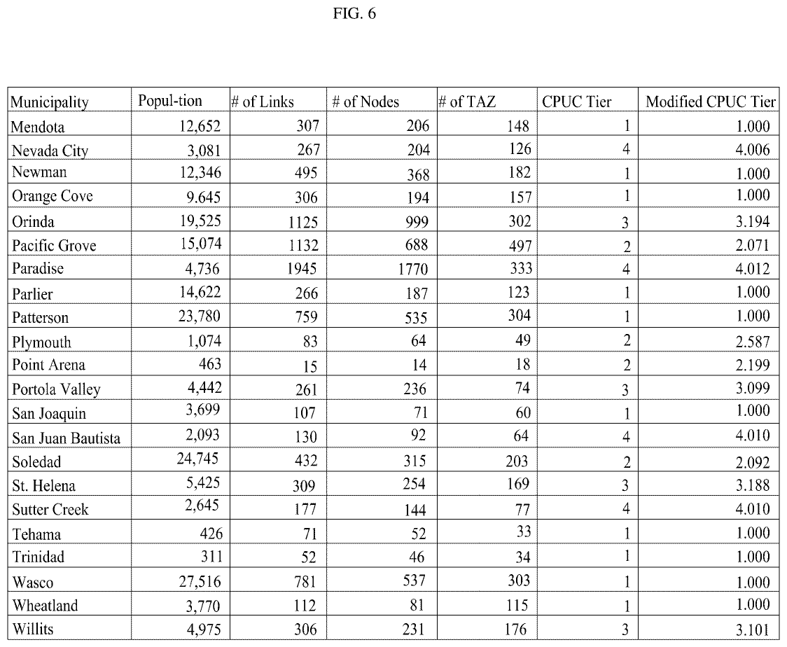

FIGS. 5 and 6 summarize the demographic and graph-theoretic characteristics, CPUC ratings, and the number of TAZs of the studied cases. Here, the TAZ represents an exogenously defined geographical unit.

### (4) Link Failure Model

Failure (blocking) probability of each road is considered based on the level of exposure to wildfires. To this end, the relative fire threat of each TAZ indexed to t is calculated. The relative fire threat is indicated as r(t)∈[0,1]. Existing vegetation cover data provided by the U.S. government utilizes data that represents an estimated vertical coverage rate of a live canopy layer for 30-meter cell. This data provides a coverage rate for each of trees, shrubs, and grasses, as a percentage. The average vegetation coverage rate of each TAZ is calculated using QGIS. Since wildfire selectivity across land cover types decreases according to an increase in fire scale, it may be assumed that three vegetation types contribute equally to the relative fire threat in each TAZ. Therefore, relative fire threat is calculated by taking the average of cover for three vegetation types as a percentage. A TAZ with a full vegetation coverage rate has a relative fire threat rate of 100%, while a TAZ with no vegetation type is 0%. Instead, a GIS-based approach (e.g., Arango, E., Nogal, M., Sousa, H. S., Matos, J. C., & Stewart, M. G. (2023). GIS-based methodology for prioritization of preparedness interventions on road transport under wildfire events. International Journal of Disaster Risk Reduction, 99, 104126.) may be used to estimate the contribution of different vegetation types to exposure levels.

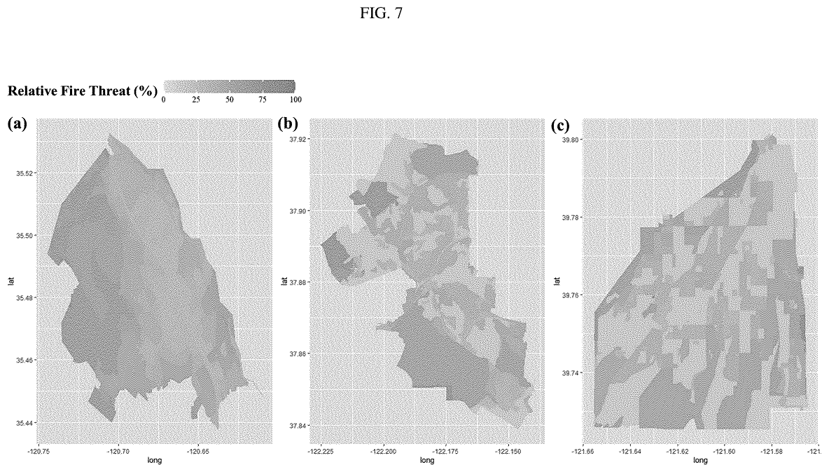

FIG. 7 illustrates the relative fire threat calculated for each TAZ in each of three municipalities (e.g., Atascadero, Orinda, and Paradise). A TAZ with a relatively higher vegetation coverage rate has a higher relative fire threat.

Failure probability f(i) of link i may be calculated by considering all of a length of each link and the relative fire threat of TAZ(s) to which the link belongs. The failure probability for unit length (e.g., 1 kilometer within TAZ t) of each link is set to F_{TAZ}(t)=φ·r(t). Here, φ represents an adjustable universal wildfire occurrence factor within [0,1]. That is, unit escape success probability is set to 1−F_{TAZ}(t) per unit length. The length of link i within TAZ t is l(i, t), and is 0 if the link is not included in the TAZ. The longer the link length Σₜl(i, t), the higher the link failure probability due to failure in a part of the link. To ensure the evacuation from the start to the end, none of subsets of the link should fail. Therefore, the escape success probability of the link may be given as Equation 4.

$$f ( i ) = 1 - s ( i ) = 1 - {\prod }_{t} {( 1 - {F}_{TAZ} ( t ) )}^{l ( i , t )} \qquad [ Equation 4 ]$$

### (5) Simulation Assumption

Demand for each origin within a municipality is estimated based on 2020 U.S. demographic information for each TAZ. The example embodiments assume that all vehicles in all households are used for evacuation during wildfires without vehicle sharing. According to 2020 U.S. demographic data, the average number of people and vehicles per household in 2017 were 2.53 and 1.88, respectively. Considering the statistics, the number of vehicles used for evacuation of each TAZ is conservatively estimated by dividing the population by 1.25 (≤2.53/1.88). Origins of vehicles are assumed to be randomly distributed within each TAZ.

A phased evacuation strategy is assumed in which 40% of the total population evacuates within the first 30 minutes after wildfire, the remaining 40% evacuates within 30 to 60 minutes, and the remaining 20% evacuates within 90 minutes. The above numerical values may be determined based on previous studies simulating wildfire evacuation. Also, it is assumed that an evacuee selects a shortest path to a destination node closest to a point of departure. Regarding a routing procedure, it is assumed that people select an evacuation path based on traffic information updated based on a time unit rather than in real time, considering closed links.

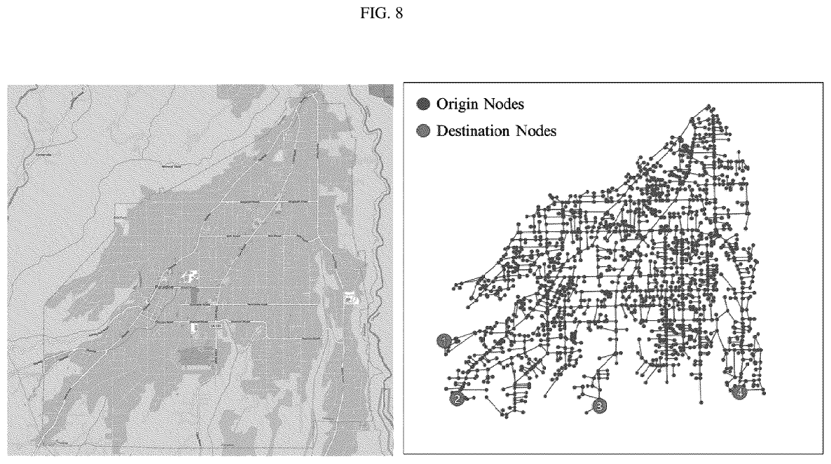

In the example embodiments, it is assumed that some roads will be closed due to amber fire after 60% of all vehicles in the corresponding municipality are safely evacuated. Also, a destination node is determined based on the OpenStreetMap network. In particular, nodes at the end of highway links are selected as destination nodes. However, if there are no highways within the municipality, nodes at the end of major arterial roads may be selected instead. The nodes are selected since the nodes serve as paths that lead to other municipalities. For example, FIG. 8 illustrates an example of Paradise. Four numbered circles represent selected destination nodes of the Paradise's road network. The number of exit nodes in each municipality may vary depending on the geometry of the road network.

According to the example embodiment, the evacuation vulnerability of a corresponding area may be measured through a framework for systematically identifying municipalities that are vulnerable to wildfires and prone to evacuation failure due to unreliable network performance. VM that is an evacuation vulnerability indicator may consider a realistic evacuation demand calculated through the failure probability of an evacuation path and a modified Dijkstra algorithm. Also, through the framework according to the present invention, critical road links may be identified using a traffic-based link criticality measure (LCᵢ¹) and a network impact-based criticality measure (LCᵢ²). Managing the top 10% critical link lengths may significantly reduce VM using all link criticality measures.

Through an integration procedure, it is possible to determine a municipality and a road link to be specifically managed within given budget. It is concise and easily reproducible, providing explanation probability and computational efficiency. Therefore, this applies not only to municipalities in California but also anywhere in the world, and may be used to strengthen municipalities' resilience to wildfires and other natural disasters that involve random road link closures.

The apparatuses described herein may be implemented using hardware components, software components, and/or combination thereof. For example, the apparatuses and components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable storage mediums.

The methods according to some example embodiments may be configured in a form of program instructions performed through various computer methods and recorded in non-transitory computer-readable media. Here, the media may continuously store computer-executable programs or may temporarily store the same for execution or download. Also, the media may be various types of recording devices or storage devices in a form in which one or a plurality of hardware components are combined. Without being limited to media directly connected to a computer system, the media may be distributed over the network. Examples of the media may include magnetic media such as hard disks, floppy disks, and magnetic tapes; optical media such as CD-ROM and DVDs; magneto-optical media such as floptical disks; and hardware devices that are specially configured to store and perform program instructions, such as ROM, RAM, flash memory, and the like. Examples of other media may include recording media and storage media managed by an app store that distributes applications or a site, a server, and the like that supplies and distributes other various types of software.

While this disclosure includes specific example embodiments, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A wildfire evacuation vulnerability evaluation method of a computer device comprising at least one processor, the wildfire evacuation vulnerability evaluation method comprising:
identifying, by the at least one processor, wildfire vulnerable areas and critical roads for wildfire evacuation within the wildfire vulnerable areas through a wildfire evacuation vulnerability measure based on origin-destination pairs and failure probability for each road due to wildfires,
wherein the identifying comprises evaluating wildfire evacuation vulnerability and the critical roads based on the number of vehicles that evacuate from an origin node and escape success probability of people that evacuate from the origin node,
the evaluating of the wildfire evacuation vulnerability and the critical roads comprises performing the wildfire evacuation vulnerability measure through a Dijkstra algorithm designed to identify a path with the highest escape success probability from among paths between a set of origins and a set of destinations,
the Dijkstra algorithm applies a weight graph that considers escape success probability of each link as a link weight for all links,
the performing of the wildfire evacuation vulnerability measure comprises comparing evacuation vulnerability between traffic demand sources through a method of using traffic network data to quantify network vulnerability as the average of minimum failure probability of demand for an origin node,
the evaluating of the wildfire evacuation vulnerability and the critical roads comprises identifying links of the critical roads based on a first link criticality measure that considers traffic usage of a link during evacuation and a second link criticality measure that quantifies the overall impact due to link failure,
the first link criticality measure is defined as a value acquired by multiplying the number of evacuation vehicles expected to lose options due to link failure by the failure probability of the corresponding link,
the failure probability is calculated by considering a length of the link and a relative fire threat tier of a traffic analysis zone (TAZ) to which the link belongs, and
the second link criticality measure is applied with a normalized measure defined as a gap in vulnerability measure between an original graph and a reduced graph without the link.

2. A non-transitory computer-readable recording medium storing instructions that, when executed by a processor, cause the processor to perform the wildfire evacuation vulnerability evaluation method on a computer device,
wherein the wildfire evacuation vulnerability evaluation method comprises identifying wildfire vulnerable areas and critical roads for wildfire evacuation within the wildfire vulnerable areas through a wildfire evacuation vulnerability measure based on origin-destination pairs and failure probability for each road due to wildfires,
the identifying comprises evaluating wildfire evacuation vulnerability and the critical roads based on the number of vehicles that evacuate from an origin node and escape success probability of people that evacuate from the origin node,
the evaluating of the wildfire evacuation vulnerability and the critical roads comprises performing the wildfire evacuation vulnerability measure through a Dijkstra algorithm designed to identify a path with the highest escape success probability from among paths between a set of origins and a set of destinations,
the Dijkstra algorithm applies a weight graph that considers escape success probability of each link as a link weight for all links,
the performing of the wildfire evacuation vulnerability measure comprises comparing evacuation vulnerability between traffic demand sources through a method of using traffic network data to quantify network vulnerability as the average of minimum failure probability of demand for an origin node,
the evaluating of the wildfire evacuation vulnerability and the critical roads comprises identifying links of the critical roads based on a first link criticality measure that considers traffic usage of a link during evacuation and a second link criticality measure that quantifies the overall impact due to link failure,
the first link criticality measure is defined as a value acquired by multiplying the number of evacuation vehicles expected to lose options due to link failure by the failure probability of the corresponding link,
the failure probability is calculated by considering a length of the link and a relative fire threat tier of a traffic analysis zone (TAZ) to which the link belongs, and
the second link criticality measure is applied with a normalized measure defined as a gap in vulnerability measure between an original graph and a reduced graph without the link.

3. A computer device comprising:
at least one processor configured to execute computer-readable instructions on the computer device,
wherein the at least one processor is configured to process a process of identifying wildfire vulnerable areas and critical roads for wildfire evacuation within the wildfire vulnerable areas through a wildfire evacuation vulnerability measure based on origin-destination pairs and failure probability for each road due to wildfires,
the at least one processor is configured to evaluate wildfire evacuation vulnerability and the critical roads based on the number of vehicles that evacuate from an origin node and escape success probability of people that evacuate from the origin node,
the at least one processor is configured to perform the wildfire evacuation vulnerability measure through a Dijkstra algorithm designed to identify a path with the highest escape success probability from among paths between a set of origins and a set of destinations,
the Dijkstra algorithm applies a weight graph that considers escape success probability of each link as a link weight for all links,
the at least one processor is configured to compare evacuation vulnerability between traffic demand sources through a method of using traffic network data to quantify network vulnerability as the average of minimum failure probability of demand for an origin node,
the at least one processor is configured to identify links of the critical roads based on a first link criticality measure that considers traffic usage of a link during evacuation and a second link criticality measure that quantifies the overall impact due to link failure,
the first link criticality measure is defined as a value acquired by multiplying the number of evacuation vehicles expected to lose options due to link failure by the failure probability of the corresponding link,
the failure probability is calculated by considering a length of the link and a relative fire threat tier of a traffic analysis zone (TAZ) to which the link belongs, and
the second link criticality measure is applied with a normalized measure defined as a gap in vulnerability measure between an original graph and a reduced graph without the link.
